(19) United States
(12) Patent Application Publication
(10) Pub. No.: US 2015/0377201 A1
(43) Pub. Date: Dec. 31, 2015

(54) FUEL INJECTOR FOR AN ENGINE

(71) Applicant: Caterpillar Inc., Peoria, IL (US)

(72) Inventors: Kenth I. Svensson, Peoria, IL (US); Chad P. Koci, Washington, IL (US); Christopher Gehrke, Chillicothe, IL (US)

(21) Appl. No.: 14/316,054

(22) Filed: Jun. 26, 2014

(51) Int. Cl. F02M 61/10

(52) U.S. Cl. CPC F02M 61/10; F02M 2700/071

(57) ABSTRACT

A fuel injector includes a body and a needle that is disposed within an internal bore defined by the body. The needle includes a distal surface that intersects with a longitudinal axis of the needle. Moreover, the distal surface also faces the internal surface of the body. The needle further includes a sealing surface that is configured to seat on a sealing surface of the body. The internal surface of the body includes an axial bearing surface disposed between a distal end of the body and the sealing surface of the body. The needle includes an axial bearing surface at least partly facing the axial bearing surface of the internal bore. The axial bearing surface of the body cooperates with the axial bearing surface of the needle to guide movement of the needle relative to the body along an axial direction parallel to the longitudinal axis of the needle.

### TECHNICAL FIELD

The present disclosure relates to a fuel injector for an engine, and more particularly to a fuel injector with a low-wobble needle.

### BACKGROUND

An injector that is used to inject fuel into a combustion chamber of an engine may include a needle disposed within an injector body. The needle is movable along an axial direction relative to the injector body to inject the fuel into the combustion chamber. During operation of the injector, the needle may move relative to the injector body in a direction transverse to the axial direction, which may be referred to as “wobble.” Such wobbling of the needle may cause undesirable injector performance.

U.S. Pat. No. 6,793,161 purports to describe a fuel injector with needle lift damping. Damping of the lift of the needle valve is carried out by extracting and leaking out the fuel in the damping chamber through the leak passage. The needle valve functions as a guide for the damper member, and prevents vibration of the damper member, thereby allowing a consistently stable movement to be obtained in the needle valve.

### SUMMARY

According to an aspect of the disclosure, a fuel injector includes a body and a needle. The body has an internal surface defining an internal bore therein. The needle is disposed within the internal bore. The needle includes a distal surface that intersects with a longitudinal axis of the needle. Moreover, the distal surface of the needle faces the internal surface of the body. The needle further includes a sealing surface that is configured to seat on a sealing surface of the body. The internal surface of the body includes an axial bearing surface disposed between a distal end of the body and the sealing surface of the body.

The needle includes an axial bearing surface that at least partly faces the axial bearing surface of the internal bore. The axial bearing surface of the body cooperates with the axial bearing surface of the needle to guide movement of the needle relative to the body along an axial direction parallel to the longitudinal axis of the needle.

According to another aspect of the disclosure, an engine includes an engine block, a piston, and a fuel injection system. The engine block defines a cylinder. The piston is slidably disposed within the cylinder. The fuel injection system is in communication with the cylinder. The fuel injection system includes a fuel pump and a fuel injector. The fuel pump is configured to pressurize fuel. The fuel injector is disposed in fluid communication with the fuel pump and the cylinder. The fuel injector is configured to supply the pressurized fuel to the cylinder.

The fuel injector includes a body and a needle. The body has an internal surface defining an internal bore therein. The needle is disposed within the internal bore. The needle includes a distal surface that intersects with a longitudinal axis of the needle. Moreover, the distal surface of the needle faces the internal surface of the body. The needle further includes a sealing surface that is configured to seat on a sealing surface of the body. The internal surface of the body includes an axial bearing surface disposed between a distal end of the body and the sealing surface of the body.

The needle includes an axial bearing surface that at least partly faces the axial bearing surface of the internal bore. The axial bearing surface of the body cooperates with the axial bearing surface of the needle to guide movement of the needle relative to the body along an axial direction defined by the longitudinal axis of the needle.

According to another aspect of the disclosure, a method for making a fuel injector includes forming an axial bearing surface on a needle that is disposed within an internal bore defined by an internal surface of a body. The method further includes forming an axial bearing surface on the internal surface of the body. The method further includes seating a sealing surface of the needle on a sealing surface of the body such that the axial bearing surface of the body and the axial bearing surface of the needle mutually cooperate to guide a movement of the needle relative to the body along an axial direction parallel to the longitudinal axis of the needle.

Other features and aspects of this disclosure will be apparent from the following description and the accompanying drawings.

### BRIEF DESCRIPTION OF THE DRAWINGS

FIG. 1 is a diagrammatic representation of an engine, according to an aspect of the disclosure;

FIG. 2 is a front sectional view of a fuel injector, according to an aspect of this disclosure, that may be employed by the engine;

FIG. 3 is a partial front sectional view of a fuel injector showing a body and a needle, according to an aspect of the disclosure;

FIG. 4 is a partial front sectional view of a body and a needle, according to an aspect of the disclosure;

FIG. 5 is a bottom sectional view of the body and the needle taken along section line A-A′ of FIG. 4;

FIG. 6 is a partial front sectional view of a body and a needle, according to an aspect of the disclosure;

FIG. 7 is a bottom cross-sectional view of the body and the needle taken along section line B-B′ of FIG. 6; and

FIG. 8 is a flowchart of a method for making a fuel injector according to an aspect of the disclosure.

### DETAILED DESCRIPTION

Aspects of the disclosure will now be discussed in conjunction with the accompanying figures. The same reference numbers will be used throughout the figures to refer to same or like parts, unless specified otherwise. Also, it may be noted that any reference to elements in the singular is also to be construed to relate to the plural and vice-versa without limiting the scope of the disclosure to the exact number or type of such elements unless set forth explicitly in the appended claims. Accordingly, reference to various elements described herein is made either collectively or individually when there may be more than one element of the same type.

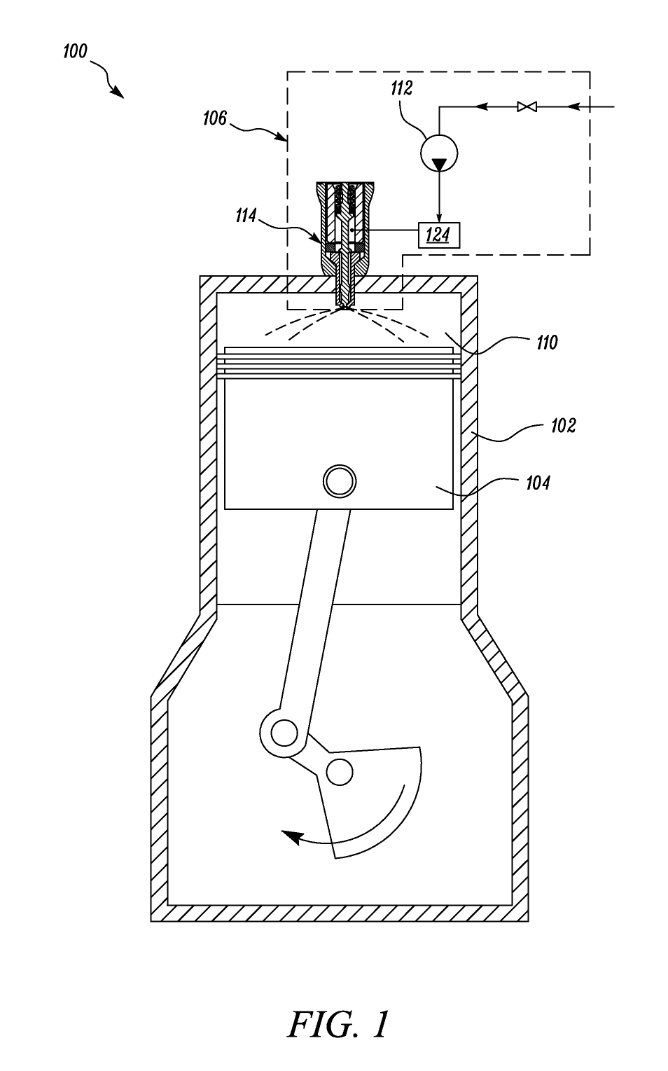

FIG. 1 illustrates a diagrammatic representation of an engine 100 according to an aspect of the present disclosure. The engine 100 may embody a compression ignition engine, a spark-ignition engine, or any type of combustion engine known to one skilled in the art. As shown in FIG. 1, the engine 100 is a single-cylinder engine. However, the engine 100 may optionally be a multi-cylinder engine having an inline configuration, a radial configuration or other configurations known to one skilled in the art.

The engine 100 may be used in various applications such as, but not limited to, transportation, for e.g., in off-highway trucks, in earth-moving machines; or for power generation, for e.g., when coupled to a generator set; or to drive turbo-machines and/or other equipment such as, for e.g., pumps, compressors and other devices known in the art.

As shown in FIG. 1, the engine 100 includes an engine block 102, a piston 104, and a fuel injection system 106. A cylinder wall 110 of the engine block 102 and the piston 104 at least partially define a combustion chamber 111. The piston 104 is slidably disposed within the cylinder wall 110.

The fuel injection system 106 is disposed in communication with the combustion chamber 111. The fuel injection system 106 may be configured to receive various types of fuel such as, but not limited to, distillate diesel, biodiesel, gasoline, natural gas, ethyl alcohol, dimethyl ether, or combinations thereof. One of ordinary skill in the art will appreciate that the fuel type may vary depending upon a type of the engine used and/or other specific requirements of an application.

The fuel injection system 106 includes a fuel pump 112 and a fuel injector 114. The fuel pump 112 is configured to pressurize the fuel. As shown in FIG. 1, the fuel injector 114 is disposed in fluid communication with the fuel pump 112 and the combustion chamber 111. The fuel injector 114 is configured to supply the pressurized fuel from the fuel pump 112 to the combustion chamber 111.

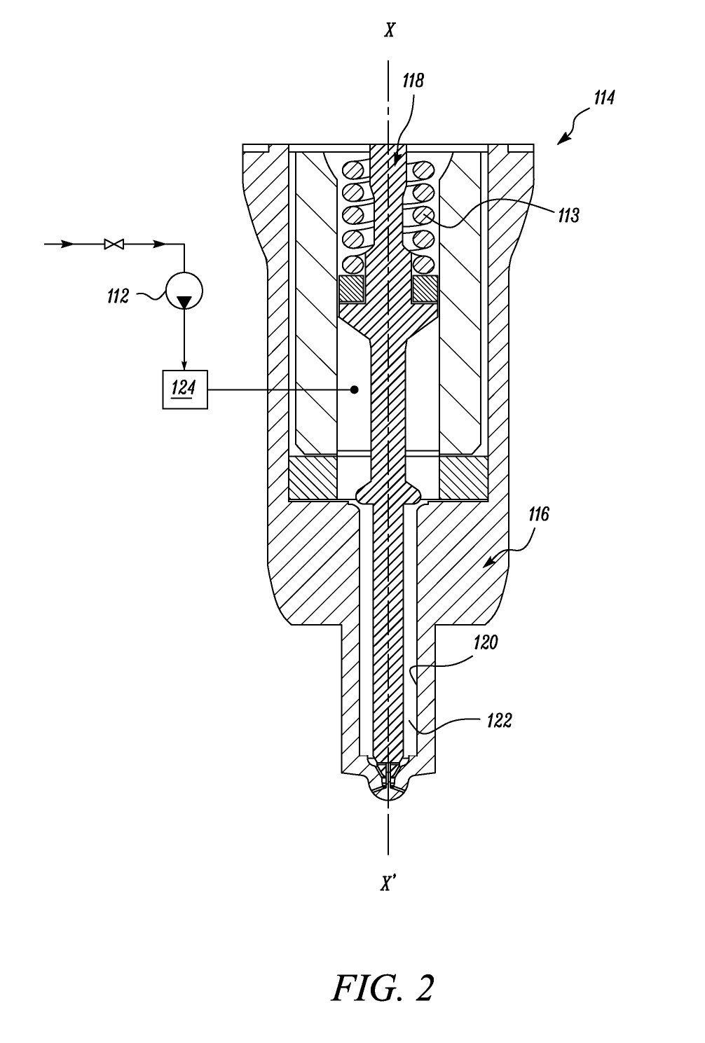

FIG. 2 illustrates a front sectional view of the fuel injector 114, according to an aspect of this disclosure that may be employed by the engine 100. Referring to FIG. 2, the fuel injector 114 includes a body 116 and a needle 118. The body 116 has an internal surface 120b defining an internal bore 122 therein. The needle 118 is disposed within the internal bore 122 and is slidably operable within the internal bore 122 of the body 116. In an aspect of the disclosure, the engine 100 further includes a fuel actuating valve 124 that is configured to selectively communicate fuel from the fuel pump 112 to the internal bore 122 of the fuel injector 114. As shown, the needle 118 is biased with the help of a spring 113. During operation of the fuel injector 114, the fuel actuating valve 124 may fluidly actuate the needle 118 by forcing the needle 118 against the biasing force of the spring 113. Therefore, the fuel actuating valve 124 is configured to control a movement of the needle 118 relative to the body 116.

The fuel actuating valve 124, downstream of the pump 112, may be solenoid operated. Moreover, such a solenoid operated fuel actuating valve 124 may be additionally disposed in communication with an Electronic Control Module (ECM) (not shown). It will be appreciated that the ECM, disclosed herein, may be readily implemented for use with the fuel injector 114. Moreover, the ECM disclosed herein may optionally include various associated system hardware and/or software components such as, for example, input/output (I/O) devices, analog-to-digital (A/D) converters, processors, micro-processors, chipsets, read-only memory (ROM), random-access memory (RAM), and secondary storage devices, but not limited thereto. Such associated system hardware may be configured with various logic gates and/or suitable programs, algorithms, routines, or protocols in order to execute the functions of the fuel actuating valve 124 that are consistent with the present disclosure.

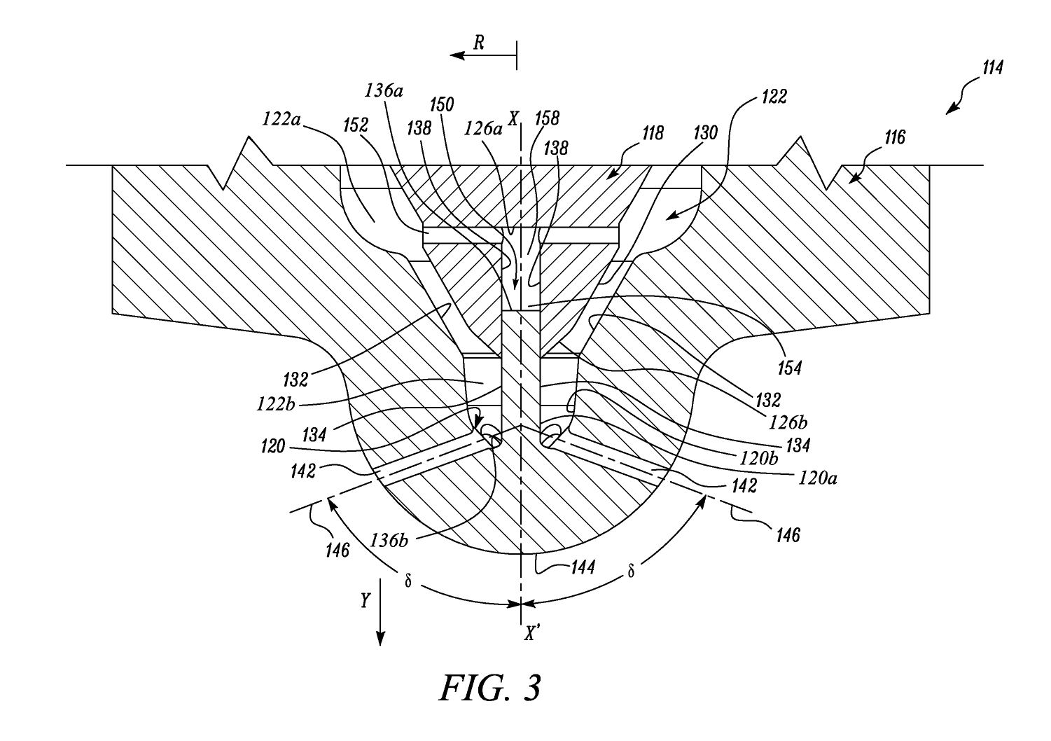

FIG. 3 is a front sectional view of the fuel injector 114 showing the body 116 and the needle 118, according to another aspect of this disclosure. As shown in FIG. 3, the needle 118 includes a distal surface 126a that intersects with a longitudinal axis X-X′ of the needle 118. Further, the distal surface 126b of the needle 118 may face a portion 120b of the internal surface 120 of the body 116.

The needle 118 further includes a sealing surface 130 that is configured to seat on a sealing surface 132 of the body 116. The internal surface 120a of the body 116 includes an axial bearing surface 134 disposed between a distal end 136b of the body 116 and the sealing surface 132 of the body 116. The needle 118 includes an axial bearing surface 138 at least partly facing the axial bearing surface 134 of the body 116. The axial bearing surface 134 of the body 116 cooperates with the axial bearing surface 138 of the needle 118 to guide movement of the needle 118 relative to the body 116 along an axial direction Y parallel to the longitudinal axis X-X′ of the needle 118.

With continued reference to FIG. 3, a portion 120b of the internal surface 120 of the body 116 is disposed downstream of the sealing surface 132 relative to a direction of flow through the injector 114 and extends upwardly; and a portion of the distal surface 126b of the needle 118 is correspondingly configured to depend downwardly. This way, the needle 118 may be positioned at least partly within the internal bore 122 of the body 116 and the axial bearing surfaces 134, 138 of the body 116 and the needle 118 may mutually cooperate during operation of the fuel injector 114.

According to another aspect of this disclosure, a profile of the axial bearing surface 134 of the body 116 may be configured to match with a profile of the axial bearing surface 138 of the needle 118. For example, a profile of the internal bore 122 and a corresponding profile of the needle 118 may be circular, oval, polygonal, or any type of profile commonly known in the art. The matching profiles may allow the axial bearing surface 138 of the needle 118 and the axial bearing surface 134 of the body 116 to cooperate with each other and may establish a sliding contact therebetween.

According to another aspect of the disclosure, the body 116 further defines a plurality of orifices 142 therethrough (two orifices 142 shown in the sectional view of FIG. 3). The orifices 142 are disposed between the sealing surface 132 of the body 116 and the distal end 136b of the body 116 along the axial direction Y. The orifices 142 extend from the internal surface 120b of the body 116 to an outer surface 144 of the body 116. Moreover, as illustrated in FIG. 3, the orifices 142 are arranged in a circumferential array about the longitudinal axis X-X′ of the needle 118. However, it should be noted that other configurations or arrangements of orifices 142 on the body 116 may optionally be contemplated depending on specific requirements of an application.

The angle δ between the axis 146 of each orifice 142 and the longitudinal axis X-X′ may be beneficially kept between 5 degrees and 85 degrees. For example, in one application, the angle δ may be kept at 55 degrees. In another application, the angle δ may be kept at, for example, 65 degrees. In yet another application, the angle δ may be kept at, for example, 75 degrees. However, it will be appreciated by persons having skill in the art that this angle δ may vary from one application to another depending on specific requirements of an application such as, but not limited to, pressure required in the injected fuel, fuel-spray pattern required in the combustion chamber 111, a location of the piston 104 at the time of fuel injection, and the like.

According to another aspect of the disclosure, the needle 118 defines a vent channel 150 extending from a first vent port 152 to a second vent port 154. The first vent port 152 is disposed above the sealing surface 130 of the needle and at least partly faces a radial direction R, the radial direction R being perpendicular to the longitudinal axis X-X′ of the needle 118. However, the first vent port 152 may be inclined at any suitable angle relative to the longitudinal axis X-X′ of the needle 118. The second vent port 154 at least partly faces the distal end 136a of the body 116 along the axial direction Y.

In one aspect of the disclosure, a portion 158 of the vent channel 150 is disposed adjacent to the distal surface 126a of the needle 118 and the distal end 136a of the body 116. With this configuration of the vent channel 150, fuel that is trapped between the distal surface 126a of the needle 118 and the distal end 136a of the body 116 during movement of the needle 118 relative to the body 116 may be vented out into the internal bore 122a of the body 116 that is disposed above the sealing surface 132 of the body 116.

Explanation pertaining to an operation of the fuel injector 114 will be made hereinafter in conjunction with FIGS. 1-3. As disclosed herein, the fuel actuating valve 124 is configured to bring about movement of the needle 118 relative to the body 116 i.e., along the longitudinal axis X-X′ of the needle 118. During operation of the fuel injector 114, the needle 118 may be lifted so as to break a contact between the sealing surface 130 of the needle 118 and the sealing surface 132 of the body 116. Pressurized fuel that is present in the internal bore 122a located above the sealing surface 132 may now enter the internal bore 122b that is below the sealing surface 132 of the body 116 i.e., the pressurized fuel may flow towards the distal end 136b of the body.

After a predetermined amount of time and/or volume of fuel entering the internal bore 122b of the body 116 that is below the sealing surface 132 of the body 116 and/or adjacent to the orifices 142, the needle 118 may be lowered within the internal bore 122 i.e., towards the distal end 136b of the body 116. Lowering the needle 118 within the internal bore 122 of the body 116 allows the distal surface 126b of the needle 118 to cooperate with the internal surface 120b of the body 116 and push the pressurized fuel out of the orifices 142 and into the combustion chamber 111.

Moreover, the vent channel 150 promotes fluid communication between the distal end 136a of the body 116 and the internal bore 122b, thereby providing a channel for venting of the fuel as the needle 118 translates toward the distal end 136b of the body 116.

Therefore, to mitigate the possibility of a hydro-lock occurring between the needle 118 and the body 116, the vent channel 150 may route the remnant fuel, i.e., the fuel left behind at the distal end 136a of the body 116 and/or the distal end 136b adjacent to the orifices 142, to the internal bore 122a of the body 116 that is located above the sealing surface 132. With pressure of the fuel located adjacent to the orifices 142 being higher than that above the sealing surface 132 of the body 116, the fuel at the distal end 136a of the body 116 and/or the distal end 136b adjacent to the orifices 142 may be urged to enter the second vent port 154.

Thereafter, as the needle 118 progresses downwardly within the body 116, the sealing surface 130 of the needle 118 may make contact with the sealing surface 132 of the body 116 and the fuel in the vent channel 150 may be pushed out into the internal bore 122a disposed above the sealing surface 130 in the radial direction R via the second vent port 154. Moreover, in another aspect of this disclosure, a volume defined by the internal bore 122b below the sealing surface is kept minimal to reduce a possibility of fuel dribbling out of the orifices 142 and into the combustion chamber 111.

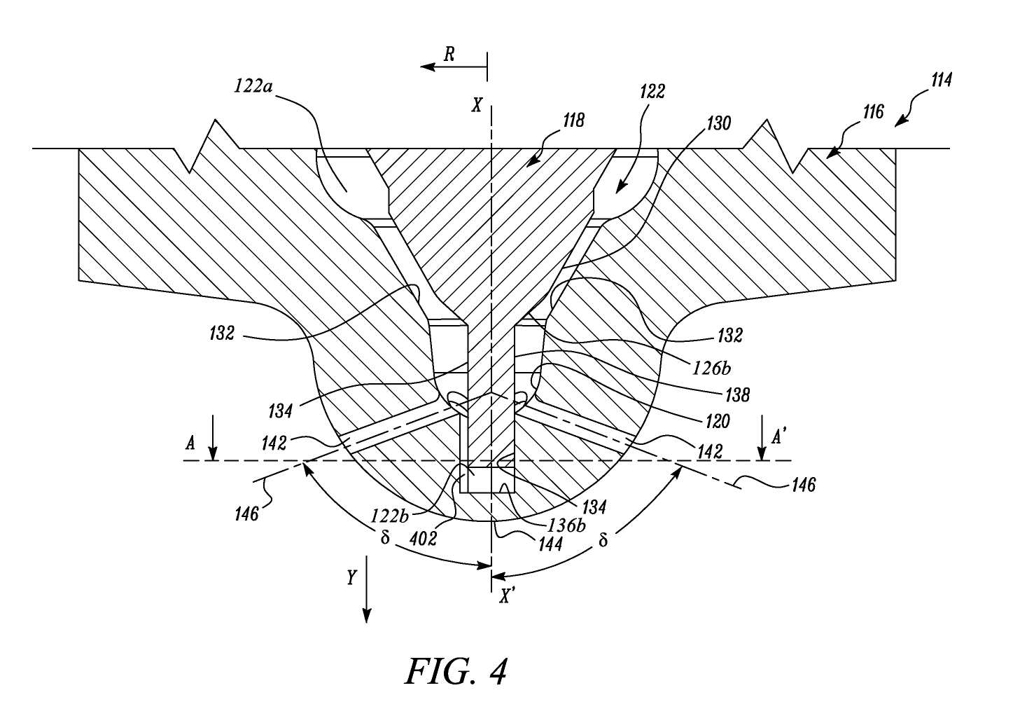

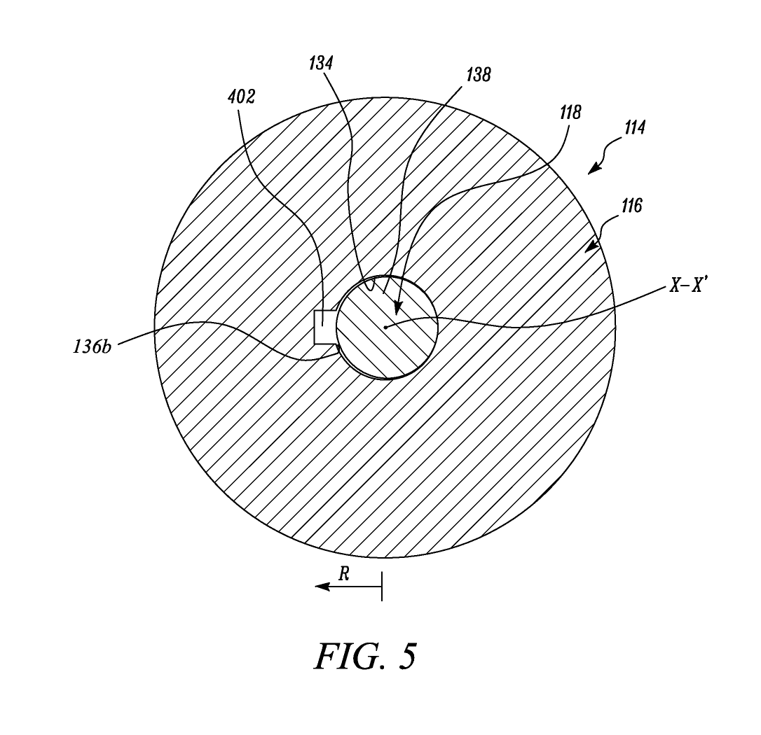

FIG. 4 illustrates a cross-sectional view of the body 116 and the needle 118, according to another aspect of this disclosure, and FIG. 5 illustrates a bottom sectional view of the body 116 and the needle 118 taken along section line A-A′ of FIG. 4. Referring to FIGS. 4 and 5, the internal bore 122b of the body 116 disposed adjacent to the longitudinal axis X-X′ of the needle 118 depends downwardly towards the outer surface 144 of the body 116. Further, the distal surface 126b of the needle 118 adjacent to the longitudinal axis X-X′ of the needle 118 depends downwardly to allow an inter-fitting or mating relationship between the axial bearing surfaces 138, 134 of the needle 118 and the body 116.

Moreover, as best seen in FIG. 5, a cross-section of the internal bore 122b located between the distal ends 136a and 136b of the body 116 is in the shape of a key-hole while a cross-section of the needle 118 is kept circular. The key-hole shaped cross section of the internal bore 122b adjacent to the distal end 136b of the body 116 includes a vent channel 402 extending longitudinally within the body 116 i.e., the vent channel 402 is disposed along axial direction Y parallel to the longitudinal axis X-X′ of the needle 118 (See FIG. 4), and extends in the radial direction R away from the axial bearing surface 134 of the body 116 (See FIG. 5).

Although a key-hole shaped cross section is disclosed herein, it is envisioned that other asymmetrical cross sections may be alternatively implemented in lieu of the key-hole shaped cross section. Some examples of asymmetrical cross sections may include, but is not limited to, an elliptical cross section, a rectangular cross section, or other types of cross sections commonly known to one skilled in the art.

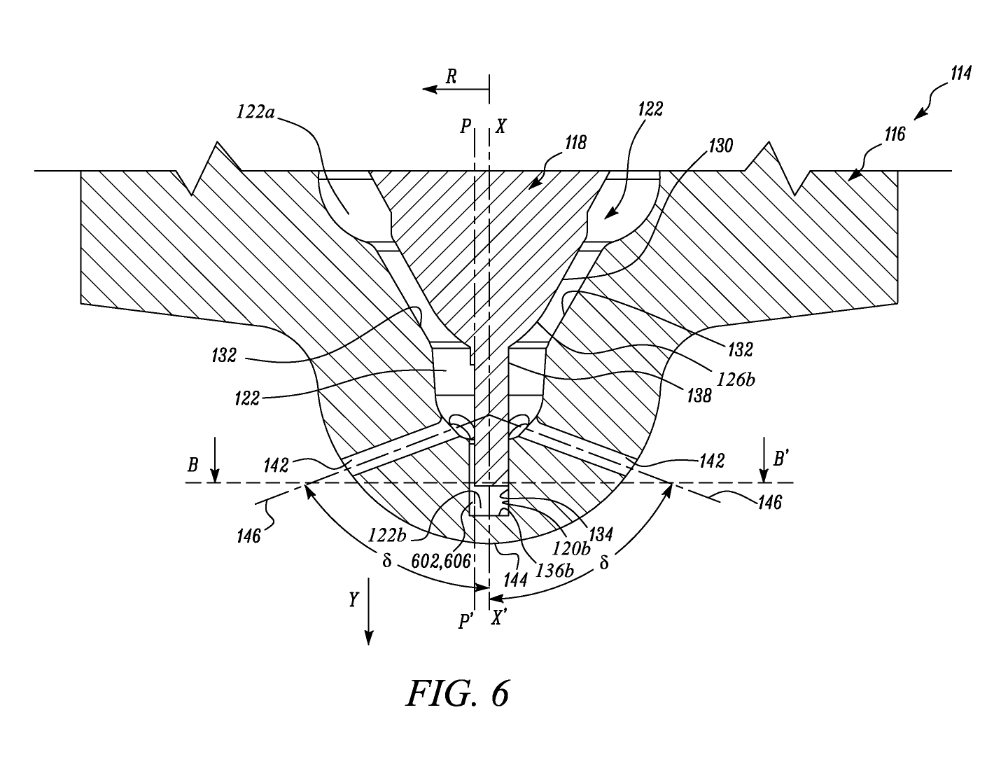

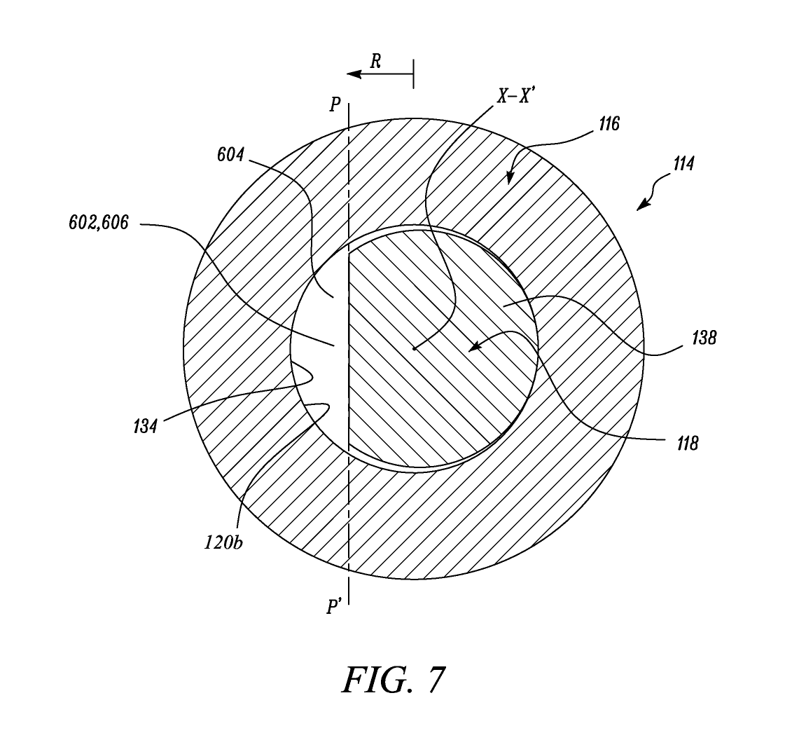

FIG. 6 illustrates a cross-sectional view of the body 116 and the needle 118, according to another aspect of this disclosure, and FIG. 7 illustrates a bottom sectional view of the body 116 and the needle 118 taken along section line B-B′ of FIG. 6. Referring to FIGS. 6 and 7, a cross-section of the internal bore 122b is in the shape of a circle (See FIG. 7), while the needle 118 is beveled along a plane P-P′ that is disposed parallel to the longitudinal axis X-X′ of the needle 118.

Moreover, in this case, a space 602 defined between the beveled surface 604 of the needle 118 and the internal surface 120b of the body 116 may be regarded as a vent channel 606 for the purposes of venting out the excess fuel located at the distal end 136b of the body 116 to the internal bore 122a of the body 116 and/or through the orifices 142. This way, the vent channel 606 may help to minimize the possibility of hydro-lock between the axial bearing surfaces 134, 138 of the body 116 and the needle 118.

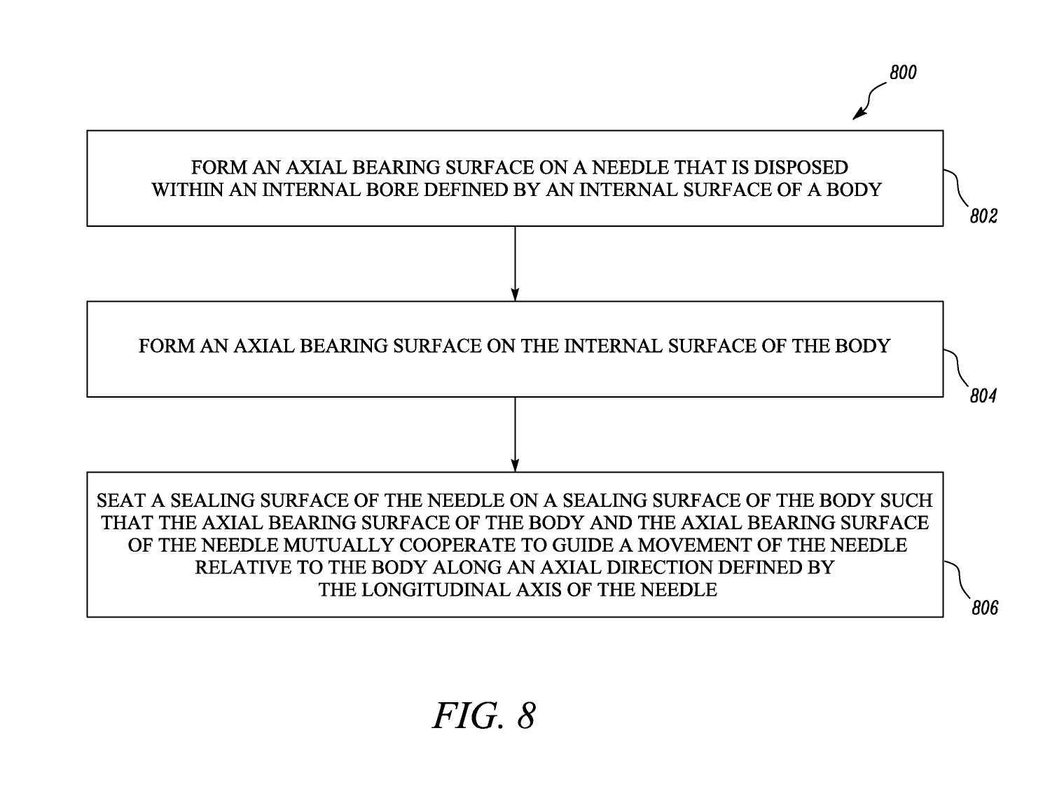

Referring to FIG. 8, a method 800 of making the fuel injector 114 is illustrated. At step 802, the method 800 includes forming the axial bearing surface 138 on the needle 118 that is disposed within the internal bore 122b defined by the internal surface 120a or 120b of the body 116.

At step 804, the method 800 further includes forming the axial bearing surface 134 on the internal surface 120a of the body 116.

At step 806, the method 800 further includes seating the sealing surface 130 of the needle 118 on the sealing surface 132 of the body 116 such that the axial bearing surface 134 of the body 116 and the axial bearing surface 138 of the needle 118 mutually cooperate to guide a movement of the needle 118 relative to the body 116. As disclosed earlier herein, the axial bearing surfaces 134, 138 of the body 116 and the needle 118 mutually cooperate to guide movement of the needle 118 along the axial direction Y defined by the longitudinal axis X-X′ of the needle 118.

In an aspect of this disclosure, the method 800 may optionally include forming the vent channel 150/402/606 for venting a fluid trapped between the axial bearing surfaces 138, 134 of the needle 118 and the body 116 to an internal bore 122a of the body 116. In one aspect of this disclosure, the vent channel 150 may be formed in the needle 118 of the fuel injector 114 (See FIG. 3). Such vent channel 150 may include the first vent port 152 and the second vent port 154, wherein the first vent port 152 disposed above the sealing surface 130 at least partly faces the radial direction R while the second vent port 154 at least partly faces the distal end 136a of the body 116 and is disposed along the axial direction Y. In another aspect of this disclosure, the vent channel 402/606 may be mutually formed by defining the cross-sections of the internal bore 122 and the needle 118 respectively (See FIGS. 4-5 and FIGS. 6-7).

It should be noted that, in methodologies directly or indirectly set forth herein, various steps and operations are described in one possible order of operation, but those skilled in the art will recognize that steps and operations may be rearranged, replaced, or eliminated without departing from the spirit and scope of the present disclosure as set forth in the claims.

Various aspects disclosed herein are to be taken in the illustrative and explanatory sense, and should in no way be construed as limiting of the present disclosure. It should be noted that individual features shown or described for one aspect may be combined with individual features shown or described for another aspect. Also, some features are shown or described in the functional context to illustrate the use of the present disclosure, however it is to be understood that such features may be omitted within the scope of the present disclosure without departing from the spirit of the present disclosure and as defined in the appended claims.

Moreover, joinder references (e.g., connected, attached, affixed, coupled and the like) are only used for identification purposes to aid the reader's understanding of the present disclosure, and may not create limitations, particularly as to the position, orientation, or use of the devices and/or methods disclosed herein. Therefore, such joinder references are to be construed broadly. Moreover, such joinder references do not necessarily infer that two elements are directly connected to each other.

### INDUSTRIAL APPLICABILITY

Typically, friction is known to occur in the cooperating surfaces of a needle and/or an injector body. Moreover, wobbling may occur in the needle leading to a disadvantageous spray pattern of the fuel within the cylinder of the engine block, including, but not limited to, circumferential non-uniformity of fuel about the axis X-X′ of the needle.

Aspects of the present disclosure have applicability for implementation and use in various fuel injection and/or engine systems. Designs of injectors disclosed herein may provide for a guided flow-path to the fuel, may increase flow coefficients, and may reduce cavitation in the injector during operation. Moreover, as shown in FIG. 3, presence of the vent channel 150 in the needle 118 may allow the needle 118 to have a reduced mass thereby allowing faster movement of the needle 118 to be possible within the body 116 when required.

Aspects of the present disclosure also provide methods for guiding a movement of the needle 118 within the body 116. With provision of the axial bearing surfaces 134, 138 and by structuring the needle 118 and the body 116 to have inter-mating features at their distal ends; the needle 118 may be configured to smoothly operate within the body 116. With this, the body 116 and/or the needle 118 may now experience reduced friction and/or wear during operation of the fuel injector 114.

With use of the aspects disclosed herein, manufacturers may configure the body and the needle of various fuel injectors to be guided in co-operational movement with each other. Hence, aspects of the present disclosure may configure the injectors to have a prolonged service life.

While aspects of the present disclosure have been particularly shown and described with reference to the aspects above, it will be understood by those skilled in the art that various additional aspects may be contemplated by the modification of the disclosed machine, systems and methods without departing from the spirit and scope of what is disclosed. Such aspects should be understood to fall within the scope of the present disclosure as determined based upon the claims and any equivalents thereof.

We claim:

1. A fuel injector comprising:
a body having an internal surface that defines an internal bore therein; and
a needle disposed within the internal bore, the needle including a distal surface intersecting a longitudinal axis of the needle, the distal surface of the needle facing the internal surface of the body,
a sealing surface of the needle being configured to seat on a sealing surface of the body,
the internal surface of the body including an axial bearing surface disposed between a distal end of the body and the sealing surface of the body,
the needle including an axial bearing surface at least partly facing the axial bearing surface of the internal bore, and
the axial bearing surface of the body cooperating with the axial bearing surface of the needle to guide movement of the needle relative to the body along an axial direction parallel to the longitudinal axis of the needle.

2. The fuel injector of claim 1, wherein a profile of the axial bearing surface of the body is configured to match with a profile of the axial bearing surface of the needle.

3. The fuel injector of claim 1, wherein the body defines a plurality of orifices therethrough, the plurality of orifices are disposed between the sealing surface of the body and the distal end of the body along the axial direction.

4. The fuel injector of claim 3, wherein the plurality of orifices extends from the internal surface of the body to an outer surface of the body.

5. The fuel injector of claim 1, wherein the needle defines a vent channel extending from a first vent port to a second vent port, the first vent port is disposed above the sealing surface of the needle and at least partly faces a radial direction, the radial direction being perpendicular to the longitudinal axis of the needle, and the second vent port at least partly faces the distal end of the body along an axial direction defined by the longitudinal axis of the needle.

6. The fuel injector of claim 5, wherein a portion of the vent channel is disposed adjacent to the distal surface of the needle and the distal end of the body.

7. The fuel injector of claim 1, wherein a cross-section of the internal bore adjacent to the distal end of the body is asymmetrical about the longitudinal axis of the needle.

8. The fuel injector of claim 1, wherein a cross-section of the internal bore adjacent to the distal end of the body is in a shape of a key-hole.

9. The fuel injector of claim 1, wherein the needle is beveled along a plane parallel to the longitudinal axis of the needle.

10. The fuel injector of claim 1 further comprising a fuel actuating valve configured to control a movement of the needle along the longitudinal axis.

11. An engine comprising:
an engine block defining a cylinder;
a piston slidably disposed within the cylinder; and
a fuel injection system in communication with the cylinder, the fuel injection system comprising:
a fuel pump configured to pressurize fuel; and
a fuel injector in fluid communication with the fuel pump and the cylinder, the fuel injector being configured to supply the pressurized fuel to the cylinder, the fuel injector comprising:
a body having an internal surface that defines an internal bore therein; and
a needle disposed within the internal bore, the needle including a distal surface intersecting a longitudinal axis of the needle, the distal surface of the needle facing the internal surface of the body,
a sealing surface of the needle being configured to seat on a sealing surface of the body,
the internal surface of the body including an axial bearing surface disposed between a distal end of the body and the sealing surface of the body,
the needle including an axial bearing surface at least partly facing the axial bearing surface of the internal bore, and
the axial bearing surface of the body cooperating with the axial bearing surface of the needle to guide movement of the needle relative to the body along an axial direction parallel to the longitudinal axis of the needle.

12. The engine of claim 11, wherein a profile of the axial bearing surface of the body is configured to match with a profile of the axial bearing surface of the needle.

13. The engine of claim 11, wherein the body defines a plurality of orifices therethrough, the plurality of orifices are disposed between the sealing surface of the body and the distal end of the body along the axial direction.

14. The engine of claim 13, wherein the plurality of orifices extends from the internal surface of the body to an outer surface of the body.

15. The engine of claim 11, wherein the needle defines a vent channel extending from a first vent port to a second vent port, the first vent port is disposed above the sealing surface of the needle and at least partly faces a radial direction, the radial direction being perpendicular to the longitudinal axis of the needle, and the second vent port at least partly faces the distal end of the body along an axial direction defined by the longitudinal axis of the needle.

16. The engine of claim 15, wherein a portion of the vent channel is disposed adjacent to the distal surface of the needle and the distal end of the body.

17. The engine of claim 11, wherein a cross-section of the internal bore adjacent to the distal end of the body is in a shape of a key-hole.

18. The engine of claim 11, wherein the needle is beveled along a plane parallel to the longitudinal axis of the needle.

19. A method for making a fuel injector, the method comprising:
forming an axial bearing surface on a needle that is disposed within an internal bore defined by an internal surface of a body;
forming an axial bearing surface on the internal surface of the body; and
seating a sealing surface of the needle on a sealing surface of the body such that the axial bearing surface of the body and the axial bearing surface of the needle mutually cooperate to guide a movement of the needle relative to the body along an axial direction defined by the longitudinal axis of the needle.

20. The method of claim 19 further comprising forming a vent channel for venting a fluid trapped between the axial bearing surfaces of the needle and the body to an internal bore of the body.
